(19) United States
(12) Patent Application Publication
(10) Pub. No.: US 2016/0364712 A1
(43) Pub. Date: Dec. 15, 2016

(54) METHOD FOR DETECTING A FRAUDULENT TERMINAL BY USING A CRYPTOGRAM, CORRESPONDING DEVICE AND PROGRAM

(71) Applicant: INGENICO GROUP, Paris (FR)

(72) Inventor: Laurent Mayer, Courdimanche (FR)

(21) Appl. No.: 15/183,374

(22) Filed: Jun. 15, 2016

(30) Foreign Application Priority Data
Jun. 15, 2015 (FR) 1555434

(51) Int. Cl. G06Q 20/20; G06Q 20/40; G06Q 20/32

(52) U.S. Cl. CPC G06Q 20/202; G06Q 20/3226; G06Q 20/405; G06Q 20/4016

(57) ABSTRACT

A method is provided for detecting a fraudulent electronic payment terminal. The method includes an act, implemented by a mobile terminal independently and prior to a transaction phase, of generating an alarm indicating that the electronic payment terminal is fraudulent. The act of generating an alarm is activated: when no message coming from the electronic payment terminal is received by the mobile terminal before expiry of a predetermined timeout period; or when a phase of verifying a response, received from the electronic payment terminal to a challenge sent out by the mobile terminal delivers a negative verification result, the act of verification being implemented by the mobile terminal.

### 1. FIELD OF THE DISCLOSURE

The field of the disclosure is that of electronic payment terminals and more specifically portable or mobile payment terminals used in a business establishment.

More particularly, the disclosure relates to the securing of such payment terminals.

### 2. PRIOR ART

Electronic payment terminals are the object of numerous attempts at hacking or theft. Indeed, owing to the nature of the information it contains and the sensitivity of the data that it processes, the payment terminal is an object of great value to malicious individuals.

A certain type of fraud is tending to become widespread. In this technique, an authentic payment terminal is replaced by a fraudulent payment terminal. The valid payment terminal is stolen in a business establishment and immediately replaced by a payment terminal that appears to be valid but has actually been either modified. This is done, for example, by integrating a fraudulent program into the terminal, making it possible to read the customers' payment means and capture its information so that this acquired information can be used to make transactions without the customer's knowledge. The payment procedure is classic for the merchant and the customer since a false receipt is also printed out. However, the fraudulent individual retrieves the customer's payment information and can therefore make transactions without the customer's being aware of it. Such a situation can therefore induce major financial losses for the customer. This type of fraud can also be done by introducing a fraudulent terminal into a fleet of existing payment terminals.

One way to resolve this problem of replacement and/or introduction is to apply a tag to the terminal. Such a tag enables a merchant to realize that his terminal has been replaced. This technique is efficient provided that the fraudulent individual is not himself capable of reproducing this tag. This technique is hence limited by the fraudulent individual's capacity to reproduce the tag. Now, for a tag to be efficient, it must be visible. But if this tag is visible, it is also visible to the fraudulent individual who can therefore easily reproduce it. Thus, this simple tagging solution is actually not efficient.

Another way to resolve this problem is to have only a wired payment terminal, i.e. a payment terminal that is physically connected to a cash register for example. This solution is of course efficient but actually unsuited to the current practice in which merchant and their customers are offered high mobility.

However, this technique is used for example in big stores or in certain types of shops.

The existing techniques are therefore limited because they are designed to avert or prevent fraud in smaller-sized businesses.

There is therefore a need to provide a technique that enables the customer to rapidly and simply make sure that the terminal he is about to use to make a transaction is truly an authentic terminal. This technique, making it possible to avert the negative effects of such fraud, must therefore be simple to implement and inexpensive.

### 3. SUMMARY

An aspect of the disclosure proposes a novel solution for the detection of a fraudulent terminal, in the form of a method for detecting a fraudulent electronic payment terminal comprising a step, implemented by a mobile terminal independently and prior to the transaction phase, for generating an alarm indicating that the electronic payment terminal is fraudulent, the step for generating an alarm being activated:
when no message coming from the electronic payment terminal is received by the mobile terminal before the expiry of a predetermined timeout period; or
when a phase of verifying a response, received from said electronic payment terminal, to a challenge sent out by said mobile terminal, delivers a negative verification result, said step of verification being implemented by said mobile terminal.

Thus, an aspect of the disclosure relies on a novel and inventive approach to the detection of the substitution and/or introduction of fraudulent terminals into a business establishment that uses a mobile terminal, for example a smartphone, carried by the customers themselves to detect the possible presence of a fraudulent terminal before carrying out a transaction with this terminal. In the event of detection of a fraudulent terminal, the method according to the an aspect of the disclosure provides for the generation of an alarm used to carry out appropriate actions, for example a verification (by human control means or by a video surveillance system, etc.) of the presence of a fraudulent terminal, at the place where the fleet of terminals is used, or a direct call to an individual responsible for the security of the fleet of terminals. The generation of this alarm can also inform the user that a proximate/neighboring payment terminal is fraudulent so as to prevent fraud before it takes place.

Thus, in a business establishment, the customer/user can use his smartphone to determine whether the payment terminal that he is about to use to make a transaction is truly an authentic payment terminal.

When this technique is carried out by the merchant himself, it enables him to make sure that none of the terminals present in his or her business is a fraudulent terminal, thus preventing his customers from being victims thereof.

This technique is especially based on exchanges of messages between the mobile terminal of a user (for example the carrier of a smart card used for a bank transaction via an electronic payment terminal) and the electronic payment terminal that this user is about to use for a transaction. In particular, these exchanges use the BLE technology currently implanted in all smartphone-type terminals and currently being implanted in electronic payment terminals.

According to an aspect of the disclosure, the phase for verifying a response comprises the following steps:
a step for the reception, by the mobile terminal, of a first message sent out by the electronic payment terminal;
a step for the sending, by said mobile terminal, to said electronic payment terminal, of a message comprising at least one challenge;
a step of reception, by said mobile terminal, of a second message sent by said electronic payment terminal, said second message comprising a response to the challenge;
a step of verification of the response by comparison of said response with a reference response, delivering a negative verification result when said comparison is negative, said step of verification being implemented by said mobile terminal.

Thus, the method of an aspect of the disclosure provides for a series of steps relative to the communication, i.e. the exchange of messages, between the mobile terminal and the payment terminal. More specifically, a message received by the mobile terminal, sent by the electronic payment terminal, comprises a response to a challenge. The method thus provides for a step for verifying this response by comparison with a piece of reference data (or reference response). Such steps, constituting a phase of verification of the response, are essential for the implementation of the method for detecting a fraudulent electronic payment terminal since they then enable the performance of the step for generating an alarm corresponding to the detection of a fraudulent electronic payment terminal.

According to an aspect of the disclosure, the method furthermore comprises a step for locating the fraudulent electronic payment terminal, and the step for generating an alarm takes account of the location of the fraudulent electronic payment terminal.

Thus, the method of an aspect of the disclosure provides for a step for locating the preliminarily detected fraudulent terminal so as to facilitate the identification of the terminal by the customer and thus avoid its use.

The location is obtained from the level of the Bluetooth signal received by the smartphone. The closer the fraudulent terminal, the stronger will the Bluetooth signal be. On the contrary, the more distant the terminal, the weaker is the Bluetooth signal. This level of received Bluetooth signal as a function of the distance between the terminals therefore provides for a relatively precise determining of the location of the fraudulent terminal. Indeed, the use of BLE technology enables precise location or position-finding to within about 10 cm which is therefore sufficient to identify a fraudulent terminal from amongst the authentic terminals in the business establishment.

According to an aspect of the disclosure, the step for generating an alarm activates a step for sending a warning message to at least one predetermined communications device.

Thus, the method for detecting according to an aspect of the disclosure provides for the sending of a warning message to a predetermined device when a fraudulent terminal has been detected. This device could be the control centre of the terminal provider or again the police. More generally, the device to which this warning message is sent enables the application of appropriate and speedy action so as to put the fraudulent payment terminal out of use.

According to an aspect of the disclosure, the method also comprises a step for the opening, by the mobile terminal, of a secured/certified application for detecting a fraudulent electronic payment terminal, aimed at simplifying and automating the implementing of the method.

According to an aspect of the disclosure, the method for detecting a fraudulent electronic payment terminal comprises the following steps implemented in an authentic electronic payment terminal:
a step for sending out a first message;
a step for receiving a message comprising at least one challenge, said message being sent out by said mobile terminal;
a step for obtaining a response to said challenge and for encrypting said response obtained, delivering a cryptogram;
a step for sending a second message comprising at least said cryptogram to said mobile terminal.

Thus, the method of an aspect of the disclosure comprises steps implemented by the electronic payment terminal aimed at communicating with the mobile terminal so as to demonstrate the fact that the payment terminal is truly an authentic terminal. To this end, this authentic terminal prepares a response to the challenge sent by the mobile terminal. Before it is sent, the response to the challenge is encrypted by the payment terminal. These steps, which are necessary to authenticate an electronic payment terminal, thus enable the application of the method by any customer who has a smartphone capable of receiving and reading these messages.

According to one particular characteristic, each of these first messages sent out by the electronic payment terminal comprises data associated with the corresponding electronic payment terminal, and this data comprises at least:
the unique universal identifier of the electronic payment terminal;
the serial number of the electronic payment terminal;
the level of the Bluetooth signal received by the mobile terminal;
a piece of information stating the capacity of the electronic payment terminal to be challenged.

Thus, the first messages sent out by the payment terminal comprise the essential information to identify the payment terminal. They also indicate the fact that the corresponding terminal is capable of being challenged in order to determine whether it is an authentic terminal or else a fraudulent terminal. For example, an older-generation terminal may be incapable of receiving a challenge and responding to it. In this case, this does not necessarily mean that it is fraudulent. This is why this information indicating the capacity of the electronic payment terminal to be challenged is useful.

According to an aspect of the disclosure, each of the second messages sent out by an electronic payment terminal comprises data associated with the electronic payment terminal and with the corresponding challenge. Thus, this data comprises at least:
an encrypted response to the corresponding challenge;
the authentic serial number of the electronic payment terminal;
the level of the Bluetooth signal received by said mobile terminal;
at least one piece of information on the context of the message.

Thus, the second messages sent out by the payment terminal include data essential for the detection of a fraudulent terminal. Indeed, the method for detecting provides for a step for decrypting (by means of the decryption key) the response sent out by the terminal and a comparison of this response with a reference response.

A terminal is therefore detected as being fraudulent when the response that it provides is erroneous, i.e. different from the reference response expected by the smartphone. This erroneous response, which is characteristic of this fraud by substitution/introduction of a fraudulent terminal, then activates the generation of the alarm to warn the customer that the terminal that he is about to use in order to make a transaction is a fraudulent payment terminal.

The information on context of the message as well as the serial number of the terminal are for example used by the secured application in order to store and list the electronic payment terminals that are tested by the customer using his mobile terminal.

An aspect of the disclosure also relates to a mobile terminal for the detection of a fraudulent electronic payment terminal comprising at least:
means of communication capable of sending out and/or receiving messages;
means for processing data contained in the messages;
means for generating an alarm, indicating the fact that a given payment terminal is fraudulent, when at least one piece of data contained in said message received from said given terminal is different from the corresponding piece of reference data.

Such a device is especially adapted to implementing the method for detecting a fraudulent electronic payment terminal. The device can be a smartphone, especially the customer's smartphone or else the merchant's smartphone, equipped with BLE technology.

An aspect of the disclosure also relates to an electronic payment terminal comprising:
communications means capable of sending and/or receiving messages;
means for processing the data contained in the messages.

Such a device is especially suited to implementing a method for detecting a fraudulent electronic payment terminal. Here it is an electronic payment terminal used for example in a business establishment.

An aspect of the disclosure also concerns a computer program product downloadable from a communications network and/or stored on a computer-readable carrier and/or executable by a microprocessor, comprising program code instructions to execute the steps of the method for detecting a fraudulent electronic payment terminal as described here above when said program is executed on a computer.

An aspect of the disclosure also concerns a computer-readable medium on which there is recorded a computer program comprising a set of instructions executable by a computer or a processor to execute the steps of the method for detecting a fraudulent electronic payment terminal as described here above when said program is executed on a computer.

### 4. FIGURES

Other features and advantages of the proposed technique shall appear more clearly from the following description of a preferred embodiment, given by way of a simple illustratory and non-exhaustive example and from the appended drawings, of which:

FIG. 1 is an example of a network of apparatuses communicating with one another according to one embodiment of the disclosure;

FIGS. 2A to 2C illustrate examples of messages exchanged between the apparatuses of the network of FIG. 1:

FIGS. 3A and 3B respectively illustrate the main steps of the method according to an aspect of the disclosure, implemented for a smartphone and an electronic payment terminal of the network illustrated in FIG. 1;

FIGS. 4A to 4D illustrate details of certain steps or sub-steps of the method of FIG. 3; and

FIGS. 5A and 5B respectively illustrate an example of a smartphone and of a payment terminal implementing the method of FIG. 3.

### 5. DESCRIPTION

### 5.1. General Principle

The general principle of an aspect of the disclosure relies on the use of a mobile terminal carried by the user to verify that the electronic payment terminal (TPE) to be used to make a transaction is a valid payment terminal, i.e. an authentic payment terminal belonging to the terminal provider. In other words, this technique is intended for the detection of the replacement of a payment terminal by a fraudulent terminal or the introduction of a fraudulent terminal into a business establishment.

This detection is especially made possible by a dialogue between the payment terminals of the merchant's fleet and the mobile terminals carried by the customers of this merchant. Each of the apparatuses uses Bluetooth Smart (registered mark) technology, also known as BLE (Bluetooth Low Energy) technology which enables a dialogue and a very precise geolocation between the apparatuses situated in a predetermined radius.

An electronic payment terminal equipped with BLE technology is thus suited for the sending, whether at regular intervals or not, of a message containing information characteristic of this terminal, to be received by a mobile terminal of a customer, a smartphone for example. Thus, when the customer approaches the electronic payment terminal, the authenticating process can begin.

The reception of the message by the customer's smartphone activates the launching of a secured application (provided that the application has been pre-installed on the smartphone) to implement the method for detecting according to the different embodiments of the disclosure, by challenging the payment terminal. To this end, the smartphone sends a challenge to the payment terminal which must then encrypt a response to the received challenge and send it back.

When the smartphone has received the encrypted response in the form of a cryptogram, it is then able to decrypt and check this response. If this response is wrong, the terminal is identified as being fraudulent, i.e. as not being an authentic terminal of the provider. Hence, if the authentic terminal has been replaced by/exchanged with a fraudulent terminal or if a fraudulent terminal has been introduced, the customer can detect its presence through his smartphone and avoid using it so as not to be defrauded.

Besides, the secured application executed on the smartphone can transmit an alert to the provider of the terminal so as to inform him that a fraudulent terminal is being used, thus enabling appropriate action (deactivation/withdrawal of the fraudulent terminal for example).

### 5.2. Description of a Network of Apparatuses to Carry Out the Method According to an Aspect of the Disclosure

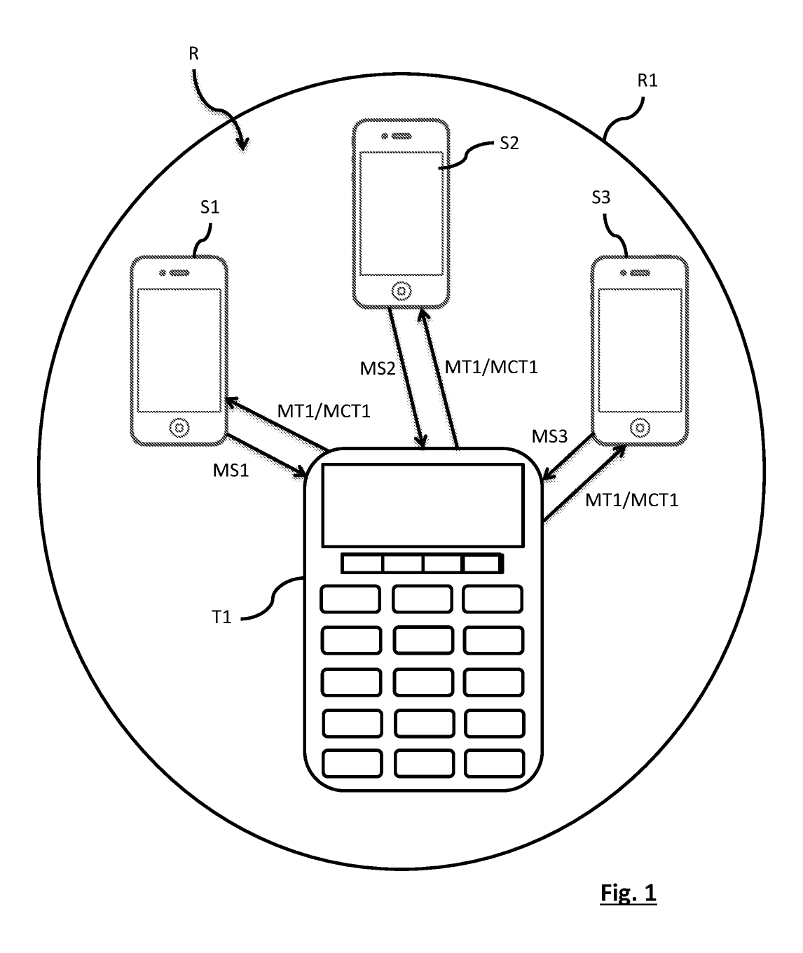

Here below, we shall consider an example of a network of apparatuses, presented in FIG. 1, to implement the method according to one particular embodiment.

This example considers a network R comprising an electronic payment terminal T1 and three mobile terminals S1, S2 and S3 (in this case smartphones) deployed in a business establishment, a restaurant for example.

In this example, each of the smartphones of the network R is potentially listening to the electronic payment terminal T1 and is capable of detecting its presence within a radius R1 demarcating the maximum range of transmission/reception of the apparatuses. The four apparatuses that implement BLE technology are therefore capable of sending and receiving messages according to the standards for this technology.

When it is provided with this BLE technology, the electronic payment terminal 1 is potentially capable of sending out two types of messages.

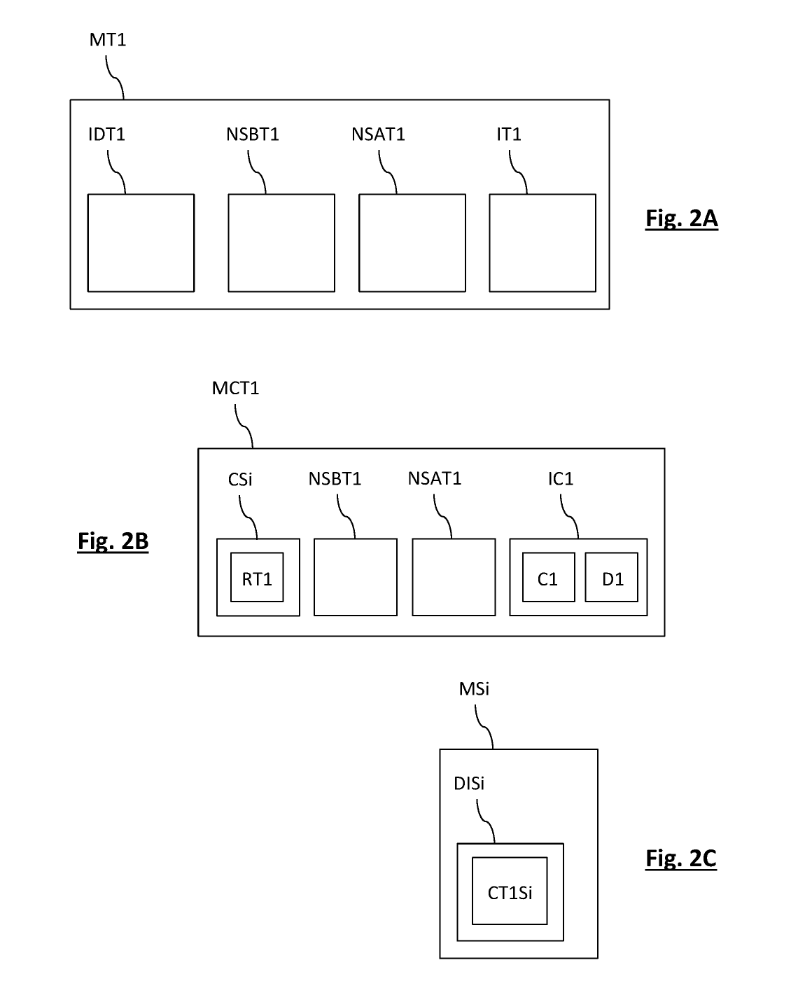

The first type of message is a non-coded message (MT1) accessible to all the apparatuses situated in the radius R1, i.e. it is a message known as a “broadcast message” or “beacon” message. This type of message therefore does not have any particular addressee (or intended recipient) and can be received by any apparatus also provided with this BLE technology. As can be seen in FIG. 2A, the message (MT1) comprises information, such as the identifier of the terminal (IDT1), the level of Bluetooth signal received (NSBT1), the authentic serial number of the terminal (NSAT1) and a piece of information (IT1) indicating its capacity to be challenged.

The second type of message sent by the terminal T1 is an encoded message (MCT1), the addressee of which is unique and clearly designated. As illustrated in FIG. 2B the message (MCT1) comprises a cryptogram (CSi) containing the response (RT1) to the challenge from the smartphone (Si), the level of Bluetooth signal received (NSBT1), the serial number of the terminal (NSAT1) and contextual information (IC1) such as the date (D1) and the time (H1).

The smartphones (Si), present in the network R demarcated by the radius R1, are capable of sending out a message (MSi) comprising a piece of interrogation data (DISi) comprising a challenge (CT1Si) to the terminal T1 (as illustrated in FIG. 2C).

In this example, each smartphone (Si) is capable of detecting the presence of the terminal T1 in the network R and of communicating with it by sending and receiving the messages described in detail below.

In general, communications between a terminal and a smartphone are made during the launching of the transaction phase, i.e. when the terminal must process a transaction.

However, a customer may start the method of detection even before the start of the transaction phase. For example, when the customer is in a check-out queue, he may open the secured application pre-installed on his smartphone and activate the method for detecting a fraudulent electronic payment terminal by hand.

### 5.3 Description of One Embodiment of the Disclosure.

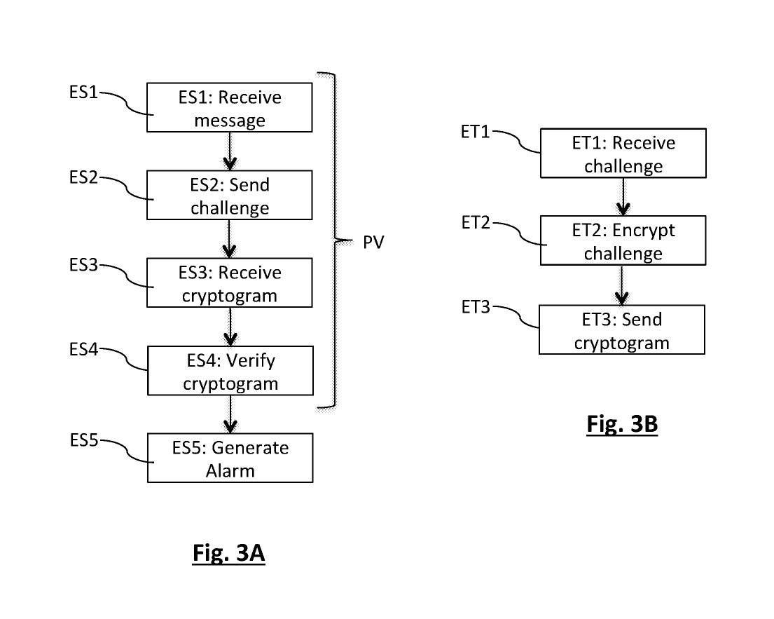

Referring now to FIGS. 3A and 3B, we present the main steps of the method implemented respectively for the smartphone S1 and the payment terminal T1 of the network R illustrated in FIG. 1.

The method for detecting a fraudulent payment terminal in a business establishment implemented by the smartphone S1 comprises mainly a step (ES5) for generating an alarm:
when no message coming from said electronic payment terminal (T1) is received by the mobile terminal (S1) before expiry of a predetermined timeout period; or
when a phase (PV) for checking a response, received from the electronic payment terminal (T1) to a challenge (CT1S1) sent out by the mobile terminal (S1) delivers a negative verification result.

More specifically, the step (PV) for checking the response sent by the terminal comprises:
a step ES1 of reception, by the smartphone S1, of the messages (MT1) coming from the terminal T1 present in a radius R1 of transmission/reception of the network;
a step ES2 for sending a challenge through a message (MS1) by the smartphone S1 to the terminal T1;
a step ES3 for receiving the cryptogram included in the message (MCT1) by the smartphone Si;
a step ES4 for verifying the validity of the cryptogram by using the smartphone S1.

The method for detecting a fraudulent payment terminal in a business establishment implemented by the terminal T1 comprises:
a step ET1 for receiving the challenge via the message (MS1) sent by the smartphone S1;
a step ET2 for encrypting the response (RT1) to the challenge (CT1S1);
a step ET3 for sending the cryptogram to the smartphone S1 via a message (MCT1).

The method for detecting according to an aspect of the disclosure can also comprise a certain number of additional or optional steps that are not illustrated:
a step EA1 for opening a secured application by means of the smartphone Si;
a step EA2 for confirming a decision to make payment by means of the smartphone Si;
a step EA3 for sending a message of alarm by means of the smartphone Si;
a step EA4 for locating the fraudulent terminal;
a step EA5 for sending out a message (MT1) by means of the terminal T1.

The method of detection can be performed automatically when the terminal T1 goes into a transaction phase or else it can be activated manually by the customer using his secured application.

Such a method is simple to implement and costs little since it requires only the downloading and installation of a secured application by the customer on his smartphone and a modification of the program of the electronic payment terminals. Indeed, the BLE technology which is installed in the majority of mobile telephones is becoming a part of most of the payment terminals on the market and the use of the method according to one or more embodiments of the of the disclosure requires no additional component.

For the electronic payment terminal, the steps of sending and receiving messages can be carried out simultaneously or one after the other without any predetermined order. Indeed, to detect a fraudulent terminal, these steps must above all be done frequently so that this terminal can be easily detected by a smartphone situated in its neighborhood and so that the setting up of communications with this smartphone can be swift.

5.3.1 The Reception of Messages Coming from the Electronic Payment Terminal by Smartphone (Step ES1)

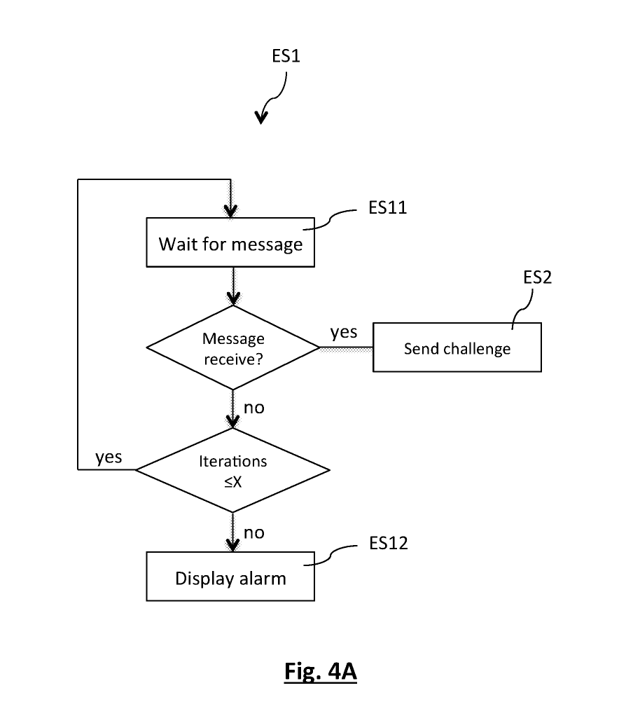

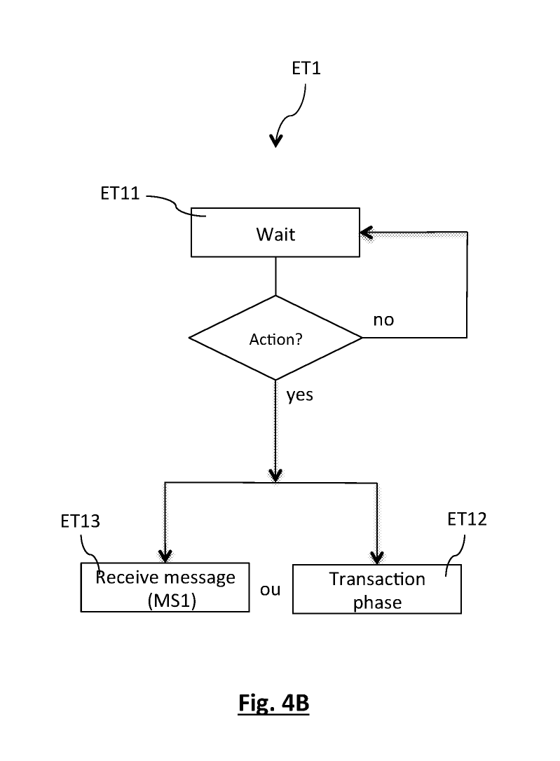

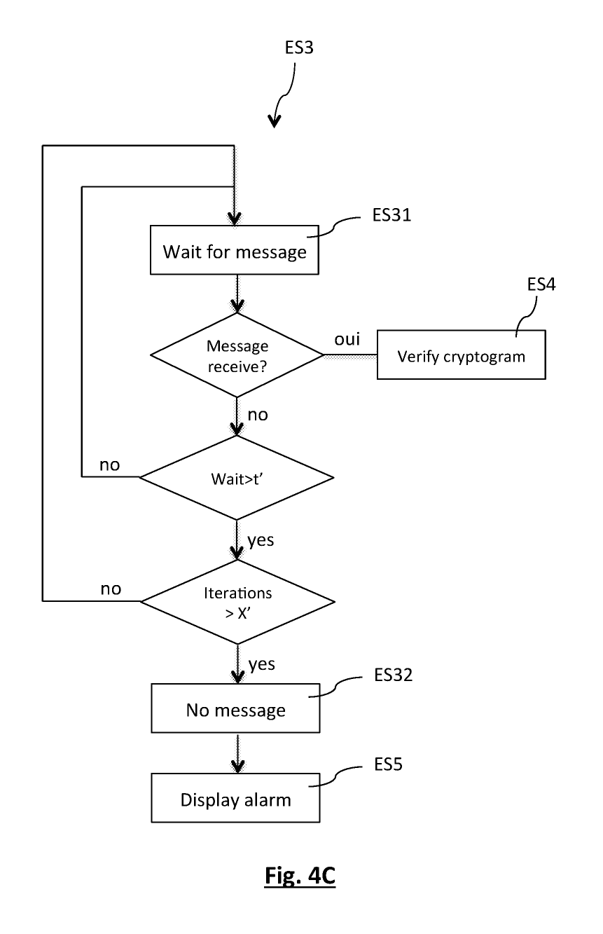

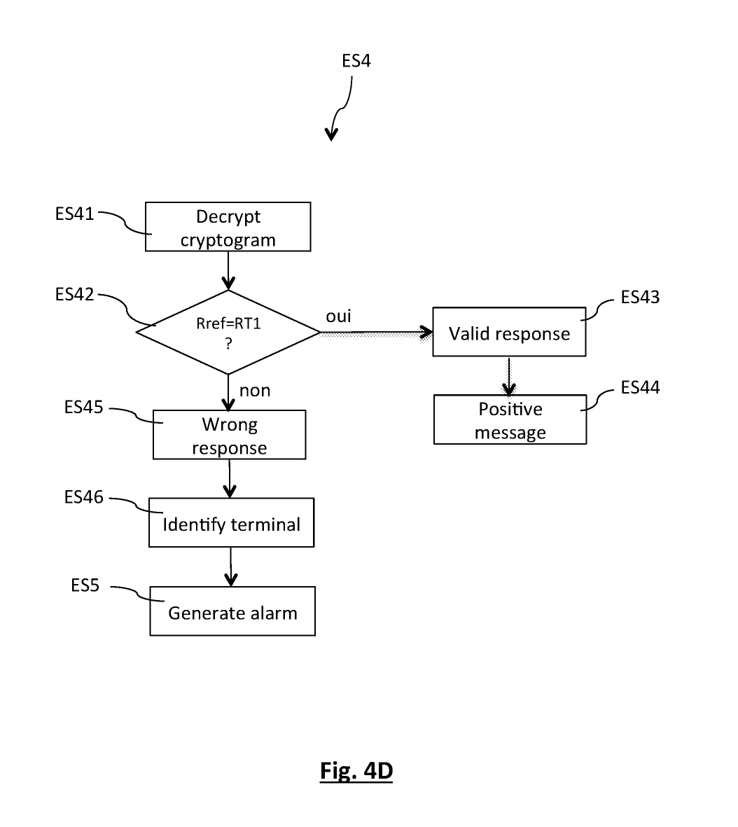

The application of the method for the detection of an aspect of the disclosure comprises a step (ES1), in which the smartphone S1 receives the broadcast message or messages (MT1) sent out by the neighboring electronic payment terminal, i.e. the electronic payment terminal situated in the radius R1 of transmission/reception of the smartphone Si. To this end, the smartphone S1 goes into a state of waiting (ES11, illustrated in FIG. 4A) for a message coming from the electronic payment terminal T1. The waiting time is predetermined and takes account for example of the possible use of the electronic payment terminal (in the phase of transaction of the preceding customer for example).

This waiting time can also be computed from the time of transmission of the messages in the network, the size of the messages sent (i.e. the information sent), the number of terminals in the fleet, etc.

During the waiting time, if no message is received, the step is performed again and repeated until reception of a message or until a predetermined number of iterations, or again until the customer interrupts the method.

Thus, if no message is received after this predetermined number of iterations X of this waiting step (ES11), an alarm is generated.

For example, the generation of the alarm consists of the display of an alarm message on the screen of the smartphone S1 (step ES12) in order to warn the customer that no communication has been made with the neighboring electronic payment terminal. One of the reasons why no message is received can be the deactivation of the Bluetooth system on the terminal T1, in particular, or again the fact that the electronic payment terminal T1 is not provided with this technology, or because it is an old model or because it is a fraudulent terminal that is not applying this technology.

### 5.3.2 The Sending of a Challenge to the Electronic Payment Terminal by the Smartphone (Step ES2)

When the smartphone S1 receives a message (MT1) coming from the electronic payment terminal T1 to be used to carry out a transaction, the smartphone S1 sends a message (MS1), the unique addressee or intended recipient which is the electronic payment terminal T1.

The message (MS1) is sent by means of the Bluetooth system of the smartphone. The choice of addressee of the message is made possible through the identifier of the terminal (IDT1) included in the message (MT1) received previously by the smartphone S1.

The message (MS1) sent by the smartphone S1 comprises especially a challenge (CT1S1) intended to determine whether the electronic payment terminal T1 is an authentic payment terminal.

The challenge (CT1S1) takes the form for example of a random string or a token type challenge of fixed size. Clearly, any type of challenge known to those skilled in the art and enabling the same goal to be attained can be implemented in an aspect of the disclosure.

### 5.3.3 Reception of the Challenge by the Electronic Payment Terminal T1 (Step ET1)

When the electronic payment terminal T1 is not in transaction phase, it goes into waiting mode (step ET11 illustrated in FIG. 4B).

This waiting step (ET11) consists either in receiving a message (MS1) from a smartphone situated in the radius R1 of transmission/reception (in this case the message (MS1) of the smartphone S1), or in receiving a piece of information or a command from the merchant aimed at activating the transaction phase.

The electronic payment terminal T1 maintains this waiting step (ET11) until an action is performed. If the electronic payment terminal T1 detects an action, two cases are possible:
case 1: the payment terminal receives a piece of information or a command from the merchant indicating the desire to carry out a transaction. The terminal then directly activates the transaction phase (step ET12), i.e. without verifying the authenticity of the electronic payment terminal T1 by the customer. The electronic payment terminal T1 is then capable of receiving the payment means from the customer (for example a smart card) and of performing the transaction process in a conventional way.
case 2: the electronic payment terminal T1 receives a message (MS1) from the smartphone S1 (step ET13) containing especially the challenge (CT1S1).

### 5.3.4 Encryption of the Response to the Challenge by the Electronic Payment Terminal T1 (Step ET2)

In case no. 2, i.e. when the electronic payment terminal T1 receives a message (MS1) from the smartphone S1, the electronic payment terminal T1 must encrypt the response to the challenge (CT1S1) included in this message (MS1), and must do so whatever the type of challenge sent by the smartphone S1.

The encryption step consists in encrypting/encoding the response (RT1) to the challenge received (CT1S1) before sending it on to the smartphone S1 for verification. This encryption consists for example in converting the response to this challenge (CT1S1) into a cryptogram (CS1).

The response (RT1) to the challenge (CT1S1) takes the form of an encrypted random string. Naturally, any type of response to this challenge, known to those skilled in the art and enabling a similar goal to be attained can be implemented in an aspect of the disclosure.

### 5.3.5 Sending of the Cryptogram by the Electronic Payment Terminal T1 to the Smartphone S1 (Step ET3)

After having encoded the response (RT1) to the challenge (CT1S1) in a cryptogram (CS1), the terminal T1 sends a message (MCT1), the unique addressee of which is the smartphone S1.

The message (MCT1) comprises the cryptogram (CS1), the level of Bluetooth signal received (NSBT1), the serial number of the electronic payment terminal T1 (NSAT1), useful for the identification of the terminal, and contextual information such as the date (D1) and time (H1) to which the message (MCT1) is sent.

### 5.3.6 Reception of the Cryptogram by the Smartphone S1 (Step ES3)

The implementation of the method of detection of an aspect of the disclosure comprises the step (ES3) in which the smartphone S1 receives the message (MCT1) sent by the electronic payment terminal and comprising especially the cryptogram (CS1).

Thus, following the sending of the message (MS1) comprising the challenge (CS1) by the smartphone S1, this smartphone goes into a state of waiting (step ES31, illustrated in FIG. 4C), for the message (MCT1) coming from the electronic payment terminal T1.

The waiting time (t′) is predetermined and takes account for example of the time of transmission of messages in the network, the size of the messages sent (i.e. information sent), number of apparatuses in the fleet, etc.

During this waiting time, if the message (MCT1) comprising the cryptogram (CS1) is received, the step (ES4) for verifying the cryptogram, described in detail below is carried out.

If, at the end of this waiting time (t′), no message is received, the waiting step (ES31) is performed again and repeated until reception of a message (MCT1) or until a predetermined number of iterations X′ or again until the method is interrupted by the customer.

Thus, if no message is received after this predetermined number of iterations X′, an alarm is generated (step ES5).

The step for generating the alarm (ES5) is described in detail below

### 5.3.7 Verification of the Validity of the Cryptogram by the Smartphone S1 (Step ES4)

The message (MCT1) received during the preceding reception step (ES3) is then processed by the smartphone S1. To this end, this smartphone carries out a verification of the validity of the cryptogram (CS1) contained in the message (MCT1) in order to detect whether the electronic payment terminal T1 is authentic or else fraudulent with reference to the steps illustrated in FIG. 4D.

First of all, the cryptogram (CS1) is deciphered/decrypted by the smartphone by means of a decipherment key (step ES41). This decipherment key, specific to each of the authentic terminals, is for example retrieved by the secured application of the smartphone on a dedicated server or else on a secured element contained in the smartphone (a secured library containing at least one adapted decipherment key).

The decipherment key of the cryptogram cannot be transmitted in the message (MCT1) because if the message were to be intercepted, by the fraudulent individual for example, it could then decipher the information included in the cryptogram (CS1).

After decryption of the cryptogram (CS1), the smartphone S1 compares the response (RT1) sent by the electronic payment terminal T1 to the challenge (CT1S1) of the smartphone S1 with an expected response, called a reference response (Rref). This reference response is characteristic of the authentic terminals and can be verified via a distinct control application capable of verifying the validity of a cryptogram, this control application being accessible (online) or installed in the smartphone.

The verification of the response (RT1) comprises a step of comparison (ES42) with a reference response (Rref). During this step (ES42) of comparison, two cases are possible:

case 1 (step ES43): the response (RT1) of the electronic payment terminal T1 corresponds to the response (Rref) expected by the smartphone S1. This result indicates that the electronic payment terminal T1 is authentic, i.e. that it is not a fraudulent terminal (according to the criteria taken into account in an aspect of the disclosure) and that the customer can carry out the transaction without risk that his payment data are picked up.

case 2: the response (RT1) of the electronic payment terminal T1 differs from the response (Rref) expected by the smartphone S1. The electronic payment terminal T1 is then considered to be potentially fraudulent, i.e. it has been introduced or exchanged with one of the authentic terminals of the fleet.

In the case 1, i.e. when the electronic payment terminal T1 is an authentic terminal (IRT1=Rref), the smartphone S1 displays (step ES44) a positive message on the smartphone S1 indicating that the electronic payment terminal T1 corresponding to the terminal on which the transaction will be made is an authentic terminal from the terminal provider.

In the case 2, i.e. when the electronic payment terminal T1 is supposed to be a fraudulent terminal, it is identified (step ES46) by the smartphone S1 implementing the method of detection.

To this end, the smartphone S1 uses the information on the identifier (IDT1) and the serial number (NSAT1) of the electronic payment terminal T1 included in the messages (MT1 and MCT1) sent by this electronic payment terminal. When the fraudulent terminal is identified, the smartphone S1 then generates an alarm according to the step (ES5) described in detail below.

### 5.3.8 The Generation of an Alarm (Step ES5)

Should the electronic payment terminal T1 be identified as being potentially fraudulent (because the response to the challenge received by the smartphone S1 coming from the electronic payment terminal T1 is not valid), the step (ES45) delivers a piece of information on fraud relative to the electronic payment terminal T1, and the pieces of information on its identity are given during the identification step (ES46) when they are available. These pieces of information activate the generation (ES5) of an alarm, indicating that the given terminal (in this case the electronic payment terminal T1) is fraudulent. This alarm is aimed at informing the customer that the electronic payment terminal which he is about to use to make a transaction is potentially fraudulent.

In addition, this alarm can also be generated when the smartphone S1 has not received any response (ES32) to the challenge that it has sent to the electronic payment terminal T1. In this case, it is possible that the terminal has been in a situation where it is incapable of reading and/or encrypting the challenge sent by the smartphone, for example. Such a terminal is therefore considered to be potentially fraudulent.

The alarm can consist of the display of an alarm message on the communications screen of the smartphone S1, the sending of a sound/or light alarm by the phone in particular. It will be understood here that other equivalent solutions can also be implemented.

### 5.3.9 The Opening of a Secured Application by the Smartphone (Step EA1)

An optional step (EA1) of the method consists of the automatic opening of a secured application when the smartphone receives a message (MT1) from the electronic payment terminal T1. This secured application, which is necessary for implementing the method for detecting a fraudulent terminal, according to one or more different embodiments of the disclosure, can also be opened manually by the customer/user when he wishes to make a transaction.

This secured application, made available when downloaded by the provider of the payment terminals, can easily be installed on a smartphone and is simple to use.

### 5.3.10 Confirmation of a Wish to Pay by the Smartphone (Step EA2)

Another optional step (EA2) of the method consists of the automatic display, by means of the secured application, of a message requesting the confirmation, by the user, of his wish to perform a transaction, and therefore to implement the method of an aspect of the disclosure. This message can for example take the form of a window known as a “pop-up” window well known in the prior art.

A positive response from the user activates the implementing of the method for detecting while a negative response cancels the implementing of the method of an aspect of the disclosure. Such a negative response can optionally close the secured application.

### 5.3.11 The Sending of a Warning Message by the Smartphone S1 (Step EA3)

The method of an aspect of the disclosure, according to its different embodiments, optionally comprises a step (EA3) following the step (ES5) for generating an alarm when the electronic payment terminal T1 is considered to be potentially fraudulent. This step (EA3) is a step for sending a message, by means of the BLE system, on the entire broadcasting range R1. This message, called a “broadcast” message, comprises a piece of information aimed at informing any other smartphones present in the broadcasting radius R1 that a fraudulent terminal is present. The identifier and/or the serial number of this terminal, when it is known, can be transmitted by this message thus enabling other smartphones to carry out all or part of the method for detecting.

The warning message can also consist of a message sent directly to the terminal provider or providers, thus enabling these providers to carry out appropriate actions in order to remove the terminal in question from the business establishment, in the shortest possible time.

Then, as soon as the terminal provider or providers receive the warning message, they can verify the other payment terminals in the business establishment, or only the fraudulent terminal when it has been located, for example by verifying the serial numbers of each electronic payment terminal being used.

### 5.3.12 The Location of the Fraudulent Terminal (Step EA4)

An optional step (EA4) of the method for detecting according to the different embodiments of an aspect of the disclosure consists in determining the distance between the smartphone S1 and the electronic payment terminal T1 when it is fraudulent. Thus, if the electronic payment terminal T1 is confirmed as being a fraudulent terminal (ES45), the smartphone S1 can compute the distance (D) between itself and the electronic payment terminal T1.

To this end, the smartphone S1 uses the level of the Bluetooth signal received (NSBT1) from the electronic payment terminal T1. This information is especially included in the messages (MT1 and MCT1) transmitted by the electronic payment terminals T1.

According to the level of Bluetooth signal received (NSBT1), the smartphone S1 is capable of making a relatively precise estimate (to within 10 cm) of the distance (D) between itself and the electronic payment terminal T1.

Using this estimate, the user can easily identify the fraudulent terminal within the business establishment so as not to use it to carry out his transaction and thus prevent fraud.

### 5.3.13 Sending a Message by Means of the Terminal T1 (Step EA5)

Whether the electronic payment terminal T1 is an authentic terminal or else a fraudulent terminal, it can be capable of using the BLE technology to send out a message (MT1) on the broadcasting band. Indeed, once an authentic electronic payment terminal is provided with the BLE technology, it is capable of sending out a “broadcast” message of a “beacon” type. It is therefore probable that the fraudulent individuals will also provide fraudulent electronic payment terminals with this technology, so as to limit the detection of such fraudulent terminals by giving them a behavior as close as possible to an authentic terminal.

This message (MT1) is accessible to all the neighboring apparatuses situated in the radius of transmission R1 and capable of listening/receiving this message (the smartphones, S1, S2 and S3 in the present example).

As described in detail above and illustrated in FIG. 2A, the electronic payment terminal T1 sends out a message (MT1) containing its identifier (IDT1), the level of the Bluetooth signal (NSBT1), its serial number (NSAT1) and a piece of information (IT1) indicating its capacity to be challenged.

The step for sending these messages is independent of the other steps of the method and can be done randomly, or not randomly, and at regular intervals or not at regular intervals. Preferably, these messages are sent frequently so that a smartphone receives one of these messages relatively swiftly thus making it possible, almost instantaneously, to implement the method according to the different embodiments of an aspect of the disclosure. In other words, the greater the frequency with which these messages are sent, the faster it is for a user to determine whether the terminal that he is about to use to make a transaction is a fraudulent terminal or not.

### 5.4 Description of the Apparatuses of the Network According to One Embodiment

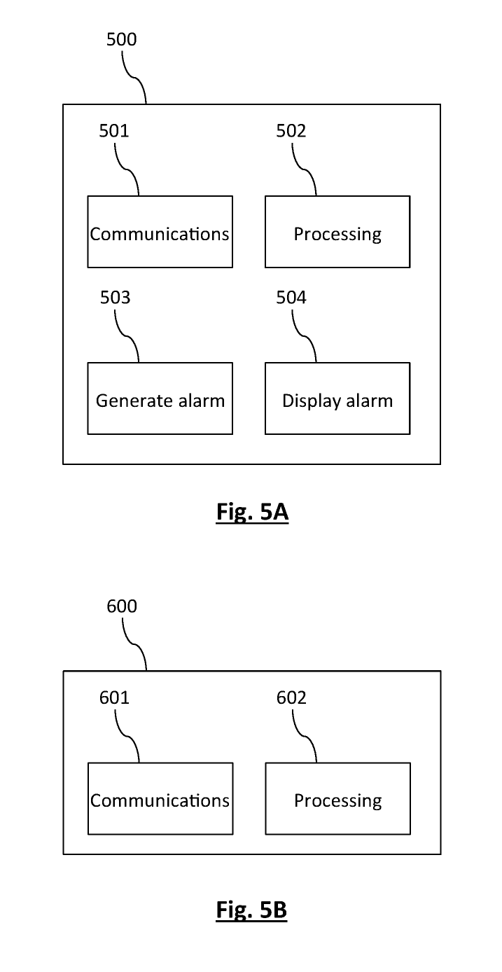

Below, referring to FIGS. 5A and 5B, we describe a smartphone as well as a payment terminal each comprising a non-transitory computer-readable medium comprising instructions stored thereon; and a processor configured by the instructions for executing the method for detecting a fraudulent terminal in the network, according to one or more different embodiments of the disclosure described above.

### 5.4.1 Description of a Smartphone of an Aspect of the Disclosure

Thus, a smartphone 500 (illustrated in FIG. 5A) according to one or more different embodiments of the disclosure comprises:

communications 501, for example in the form of one or more modules, implementing the BLE technology, capable of sending and receiving messages with one or more compatible terminals, including electronic payment terminals;

processor 502, for example a microprocessor, for example in the form of one or more modules, capable of processing the information included in the messages (in this case MCT1 and MT1) received by the smartphone so as to detect whether an electronic payment terminal (in this case the terminal T1) is fraudulent by comparing a piece of data (in the case RT1) of the message (MCT1) received with a piece of reference data (here Rref) of the authentic terminals;

alert 503 for generating an alert, for example in the form of one or more modules, when the processor 502 detects an electronic payment terminal as being potentially fraudulent; and

alarm 504 for display an alarm, for example in the form of one or more modules, seeking to inform the customer that the electronic payment terminal that has sent the messages is potentially fraudulent.

### 5.4.2 Description of an Electronic Payment Terminal of the Disclosure

Thus, a terminal 600 (illustrated in FIG. 5B) according to one or more different embodiments of the disclosure can comprise:

communications 601, for example in the form of one or more modules, implementing BLE technology, capable of sending and receiving messages with one or more compatible smartphones;

processor 602, for example a microprocessor, for example in the form of one of more modules, capable of processing the information included in the messages (in this case MS1) received by the terminal so as to prepare and encrypt a response as a function of a challenge (CTiSi) received.

### 5.5 Other Aspects and Variants

In one variant, a merchant in possession of a smartphone equipped with BLE technology can use the certified/secured application to directly apply the method for detecting of an aspect of the disclosure so as to scan the apparatuses present in his fleet, for example periodically, and thus identify the presence of a possible fraudulent payment terminal. An aspect of the disclosure therefore also enables the merchant to make sure that:

the terminals used in his business establishment are truly authentic terminals; and

his customers will not be victim of fraud when using his terminals.

In addition, if an alert is generated, it can be used in different ways. Indeed the mode of sending the alert can be configured so as to adapt as closely as possible to the needs of the users of the electronic payment terminals or to the merchants.

Besides, means other than the verification of the response of the terminal to a challenge can be used, inasmuch as they enable a response to the same set of issues and problems related to detecting the insertion of a fraudulent terminal or the replacement of an authentic terminal by a fraudulent terminal in a business establishment.

Similarly, a combination of several means, among them the verification of the response of the terminal to a challenge, can be implemented so as to optimize the performance of the method of detection according to an aspect of the disclosure, while at the same time minimizing false alerts.

In addition, the smartphone of an aspect of the disclosure comprises a memory in which it can register the identifiers of the terminals for which the method of detection of an aspect of the disclosure has been implemented at least once previously. Each terminal can thus have an associated piece of information relating to an authentic terminal or a fraudulent terminal.

This aspect makes it possible, at the customer's choice, to carry out all or part of the method of an aspect of the disclosure according to the date and/or time when the method was implemented for the last time for a given known terminal. The date and time can especially be recorded by the smartphone when it receives the message (MCT1) comprising especially these pieces of contextual information (IC1).

The method of an aspect of the disclosure offers the customer the possibility of knowing that there is a fraudulent terminal within a radius of a few meters and that it must be avoided. This information is given to him almost instantaneously and enables him not to be a victim of this fraud, thus limiting the associated financial losses.

The method of detection is implemented by the set of smartphones and terminals present in the sending/reception radius R. Thus, the fraudulent terminal can be identified as such by several smartphones. As a consequence, the warning message is sent by the different smartphones that have identified the fraud. This aspect makes it possible especially to confirm fraud and ensures that the provider of the terminals or the individuals in charge of the security of the terminals are informed.

The method of an aspect of the disclosure can also be implemented in all types of mobile electronic apparatuses or apparatuses providing services other than that of payment. Such a method of detecting of a fraudulent terminal implements BLE technology. However, the method of an aspect of the disclosure could be implemented with any other type of technology enabling short distance/range communications. For example, the method for detecting of an aspect of the disclosure could be implemented using WIFI (registered mark) technology.

Although the present disclosure has been described with reference to one or more examples, workers skilled in the art will recognize that changes may be made in form and detail without departing from the scope of the disclosure and/or the appended claims.

1. A method for detecting a fraudulent electronic payment terminal, wherein the method comprises:
an act, implemented by a mobile terminal independently and prior to a transaction phase, of generating an alarm indicating that said electronic payment terminal is fraudulent, said act of generating an alarm being activated:
when no message coming from the electronic payment terminal is received by the mobile terminal before expiry of a predetermined timeout period; or
when a phase of verifying a response, received from said electronic payment terminal, to a challenge sent out by said mobile terminal, delivers a negative verification result, said verifying the response being implemented by said mobile terminal.

2. The method for detecting a fraudulent electronic payment terminal according to claim 1, wherein said phase of verifying a response comprises the following acts:
reception, by said mobile terminal, of a first message sent out by said electronic payment terminal;
sending, by said mobile terminal, to said electronic payment terminal, of a message comprising at least one challenge;
reception, by said mobile terminal, of a second message sent by said electronic payment terminal, said second message comprising the response to the challenge;
verification of the response by comparison of said response with a reference response, delivering a negative verification result when said comparison is negative, said verification being implemented by said mobile terminal.

3. The method for detecting a fraudulent electronic payment terminal according to claim 1, wherein the method further comprises locating said fraudulent electronic payment terminal, and said act of generating an alarm takes account of said location.

4. The method for detecting a fraudulent electronic terminal according to claim 1, wherein said act of generating an alarm activates an act of sending a warning message to at least one predetermined communications device.

5. The method for detecting a fraudulent electronic terminal according to claim 1, further comprising opening, by the mobile terminal, a secured application for a fraudulent electronic payment terminal.

6. The method detecting a fraudulent electronic payment terminal according to claim 1, further comprising the following acts implemented in an authentic electronic payment terminal:
sending out a first message;
receiving a message comprising at least one challenge, said message being sent out by said mobile terminal;
obtaining a response to said challenge and encrypting said response obtained, delivering a cryptogram;
sending a second message comprising at least said cryptogram, to said mobile terminal.

7. The method for detecting a fraudulent electronic payment terminal according to claim 6, wherein said first message, sent out by the authentic electronic payment terminal, comprises data associated with the corresponding electronic payment terminal and said data comprises at least:
a unique universal identifier of said electronic payment terminal;
a serial number of said electronic payment terminal;
a level of a Bluetooth signal received by said mobile terminal;
a piece of information stating a capacity of the electronic payment terminal to be challenged.

8. The method detecting a fraudulent electronic payment terminal according to claim 6, wherein said second message, sent out by the authentic electronic payment terminal, comprises data associated with said electronic payment terminal and with the corresponding challenge, and said data comprises at least:
an encrypted response to the corresponding challenge;
an authentic serial number of said electronic payment terminal;
a level of a Bluetooth signal received by said mobile terminal;
at least one piece of information on a context of said message.

9. A mobile terminal comprising:
a non-transitory computer-readable medium comprising instructions stored thereon;
a processor configured by the instructions to detect a fraudulent electronic payment terminal, comprising:
generating an alarm indicating that said electronic payment terminal is fraudulent, said act of generating an alarm being implemented by the mobile terminal independently and prior to a transaction phase, and being activated:
when no message coming from the electronic payment terminal is received by the mobile terminal before expiry of a predetermined timeout period; or
when a phase of verifying a response, received from said electronic payment terminal, to a challenge sent out by said mobile terminal, delivers a negative verification result, said verifying the response being implemented by said mobile terminal.

10. An electronic payment terminal comprising:
a non-transitory computer-readable medium comprising instructions stored thereon;
a processor configured by the instructions to detect a fraudulent electronic payment terminal, comprising:
sending out a first message to a mobile terminal;
receiving a message from the mobile terminal comprising at least one challenge;
obtaining a response to said challenge and encrypting said response obtained, delivering a cryptogram; and
sending a second message comprising at least said cryptogram, to said mobile terminal.

11. (canceled)

12. A non-transitory computer-readable medium on which there is recorded a computer program comprising a set of instructions executable by a computer or a processor of a mobile terminal to implement a method for detecting a fraudulent electronic payment terminal, wherein the instructions configure the mobile terminal to perform:
an act, implemented by a mobile terminal independently and prior to a transaction phase, of generating an alarm indicating that said electronic payment terminal is fraudulent, said act of generating an alarm being activated:
when no message coming from the electronic payment terminal is received by the mobile terminal before expiry of a predetermined timeout period; or
when a phase of verifying a response, received from said electronic payment terminal, to a challenge sent out by said mobile terminal, delivers a negative verification result, said verifying the response being implemented by said mobile terminal.
